(19) United States
(12) Patent Application Publication
(10) Pub. No.: US 2025/0392877 A1
(43) Pub. Date: Dec. 25, 2025

(54) HEARING AID COMPRISING A SUB-BAND COMBINER

(71) Applicant: Oticon A/S, Smørum (DK)

(72) Inventors: Adel ZAHEDI, Smørum (DK); Alan WIINBERG, Smørum (DK); Aswin Adris WIJETILLAKE, Smørum (DK); Christina WASSARD, Smørum (DK); Jan PETERSEN, Smørum (DK); Rémi DECORSIÈRE, Smørum (DK); Søren Vørnle NIELSEN, Smørum (DK); Viktorija RATKUTE, Smørum (DK)

(21) Appl. No.: 19/216,770

(22) Filed: May 23, 2025

(30) Foreign Application Priority Data
Jun. 19, 2024 (EP) 24183043.9

(51) Int. Cl. H04R 25/00

(52) U.S. Cl. CPC H04R 25/70; H04R 2225/43; H04R 2225/49; H04R 2430/03

(57) ABSTRACT

Disclosed herein are embodiments of a hearing aid. The hearing aid can include a signal processor including a sub-band combiner configured to combine a plurality of sub-band combiner input signals and determine a plurality of combined sub-band signals based on a contextual parameter. Further disclosed are embodiments of a method for providing an auditory output sound.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application generally relates to the field of hearing aids, hearing loss compensation, compression, signal processing, noise reduction, and level estimation.

### BACKGROUND

In the past decade, increasing the number of noise reduction or compression channels has been a trend in the hearing aid industry. A larger number of channels has benefits, for example in terms of accurate gain shaping and tackling dominating narrowband noise. On the other hand, there are other situations where too many channels might be undesired. At high signal-to-noise ratios (SNRs), where noise is not an issue, the larger the number of compression channels, the higher the chances of unnecessary compression.

A solution that immediately comes to mind is to adaptively adjust the number of noise reduction or compression channels depending on the situation. However, changing the number of noise reduction or compression channels is undesirable for several reasons. For one, it is undesirable to have many gain maps to cope with a variable number of channels. More importantly, grouping the channels to obtain a smaller number of channels creates unjustifiable hard lines between the neighbouring channels that fall in different groups.

Instead of grouping the channels, dependency is created among the otherwise independent channels, such that the “effective” number of channels varies while the actual number of channels where gains are applied, remains constant. The transform is parametrized, e.g., the amount of dependency that is created can be controlled by changing the value of one or more parameters. The signal-to-noise ratio (SNR) may, for example, be used to control the value of the parameters.

### SUMMARY

### A Hearing Aid:

In an aspect of the present application, a hearing aid comprises an input unit. The input unit is configured to provide an audio input signal based on a sound signal. The sound signal is indicative of a sound environment. The hearing aid comprises a signal processor. The signal processor is configured to determine a plurality of sub-band signals based on the audio input signal. The signal processor comprises a sub-band combiner. The sub-band combiner is configured to combine a plurality of sub-band combiner input signals based on the sub-band signals. The sub-band combiner is configured to determine a plurality of combined sub-band signals based on a contextual parameter indicative of the sound environment. The signal processor is configured to provide, based on a processing parameter, a processed audio signal based on the audio input signal. The processing parameter is determined based on the combined sub-band signals. The hearing aid comprises an output unit. The output unit is configured to receive the processed audio signal. The output unit is configured to provide, based on the processed audio signal, an auditory output sound. The auditory output sound is indicative of the sound signal.

Thereby, an advantage of the present disclosure is a hearing aid comprising a sub-band combiner configured to create dependencies between the sub-bands of the sub-band signals. This dependency can play a crucial role in the behavior of noise reduction systems or hearing loss compensation systems, e.g., compression systems, since it can impact the coupling between processing parameters used by the noise reduction and hearing loss compensation systems. For example, often compression systems are configured to determine a processing parameter (e.g., a compression gain) based on the sub-band signals. However, if there are no dependencies between the sub-bands of the sub-band signals, the determined processing parameter used for compression, may result in a processed audio signal that will be perceived by a hearing aid user as ‘over-compressed’ and thus of low sound quality. Hence, it is desirable to determine the processing parameter based on a combined sub-band signals with dependencies between sub-bands are present. On the other hand, too much dependencies between sub-bands may result in poorer noise management of noise sources characterized by being narrow-band (i.e., narrow-band noise such as sinusoidal noise). Thereby, the compression system may be too weak at limiting the loudness of narrow-band noise.

Therefore, there is also a tradeoff when choosing the configuration of the sub-band combiner regarding how much dependencies between sub-band signals are desired. In the present disclosure, the dependencies between the sub-band signals provided by the sub-band combiner are parameterized by a contextual parameter indicative of the sound environment. For example, the contextual parameter may be a signal-to-noise ratio used to determine the degree of desirable dependencies between the neighboring sub-bands in the sub-band signals. For example, in high signal-to-noise ratio sound environments (e.g. low amounts of background noise), based on the contextual parameter, the sub-band combiner may be configured to provide the combined sub-band signals with high degree of dependencies between neighboring frequency bands so that the determined processing parameters, based on the combined sub-band signals, may result in a perceived improved sound quality since lesser degree of compression will be perceived applied on the processed audio signal. For example, in low signal-to-noise ratio sound environments (e.g. high amounts of background noise), based on the contextual parameter, the sub-band combiner may be configured to provide the combined sub-band signals with low degree of dependencies between neighboring frequency bands so that the determined processing parameters, based on the combined sub-band signals, may result in a perceived improved sound quality since loud narrow-band noise may be perceived compressed more in the processed audio signal.

The hearing aid may comprise an input unit for providing an audio input signal. The input unit may comprise an input transducer, e.g., a microphone. The input unit may be configured to pick-up a sound signal from an input transducer. The picked-up sound signal being indicative of a sound environment. The sound environment may be considered as the sound around a user wearing the hearing aid. The input unit may comprise a wireless receiver for receiving a wireless signal comprising the picked-up sound signal by an auxiliary device. The input unit may be configured to provide a plurality of audio input signals.

The audio input signal may be represented as a time domain signal. A time domain signal may be defined as a signal with a time-varying amplitude. An audio input signal may be represented as a frequency domain signal wherein a frequency domain signal may be defined as a signal with a frequency-varying amplitude and/or phase. An audio input signal may be represented as a time-frequency domain signal, wherein a time-frequency domain signal may be defined as a signal with a time- and frequency-varying amplitude and/or phase.

In an example embodiment, the audio input signal is represented in the time domain.

The audio input signal may be based on a picked-up sound signal by a microphone or a transducer sensitive to acoustic vibrations. The microphone can be understood as a transducer configured to convert acoustic energy (e.g., sound signal) to an electrical signal. The audio input signal may be based on the electrical signal. The input unit may comprise a microphone. The input unit may comprise a plurality of microphones. The input unit may comprise a plurality of transducers. The input unit may provide a plurality of audio input signals.

The sound signal picked-up by a microphone, constituting the input unit, may be an analog signal represented as a continuous signal in time and amplitude. The audio input signal may be the analog signal. The audio input signal may be converted into a digital signal represented as a discrete signal in time and amplitude. Hence, a discrete signal may be characterized by a finite time and amplitude resolution. The audio input signal may be the discrete signal. The conversion from an analog signal to a digital signal may be performed by an analog-to-digital converter (ADC). The ADC may be configured to have a pre-defined bit-resolution (e.g., an amplitude resolution) and a pre-defined bitrate (e.g., sampling frequency). The hearing aid may comprise the ADC. The hearing aid may comprise a plurality of ADCs, so that each ADC is assigned to each audio input signal represented as an analog signal.

In certain embodiments, the hearing aid can include an accelerometer. The audio input signal may be based on a picked-up accelerometer signal by an accelerometer indicative of an acceleration or a movement of the hearing aid.

The hearing aid may include more than one type of sensor to provide a plurality of audio input signals. For example, the hearing aid may include one or more Electroencephalography (EEG) sensors and/or an Electrooculography (EOG) sensors. The audio input signals may be based on EEG signals or EOG signals picked-up by electrodes, wherein the EEG signals or EOG signals are indicative of an electrical activity of the brain. The audio input signals may be provided based on different types of transducers. For example, the input unit may be configured to provide a first audio input signal, picked up by a microphone, a second audio input signal, and a second audio input signal, picked up by an accelerometer. The first audio input signal being indicative of the sound environment and the second audio input signal being indicative of a movement.

A sound environment may refer to the collection of audible sound sources within an area or space and may include reflections of sound such as reverberation and echo. A sound environment may be considered an area around a use of the hearing aid. An audible sound source may be a person speaking, a loudspeaker, or any element able to provide a sound signal. A sound signal may be characterized by a sound type which may include speech, music, alarms, tones, music, noise, etc.

The audio input signal may be pre-processed. For example, the audio input signal may be a time domain signal and pre-processed by an analysis filter bank constituting the hearing aid. The analysis filter bank may be configured to provide an analysis filter bank output signal by transforming the audio input signal into the time-frequency domain. The analysis filter bank output signal may be a time-frequency domain signal. The input unit may be configured to provide a plurality of audio input signals if the input unit receives a plurality of different types of audio input signals, e.g., from an accelerometer and a microphone. In certain examples, the input unit is configured to convert the sound signal to the audio input signal. The analysis filter bank may be configured to provide, based on the audio input signal, K₁ number of analysis filter bank output signals. Each analysis filter bank output signal may be considered a sub-band signal. A sub-band may be one of the k₁ number of analysis filter bank output signals. The hearing aid may comprise an analysis filter bank for each audio input signal.

A signal processor can be configured to receive and process the audio input signal. The signal processor may be configured to provide the audio input signals. The signal processor may be configured to provide a processed audio signal based on the audio input signal. The processed audio signal can be indicative of the sound environment. The signal processor may comprise an analysis filter bank configured to transform the audio input signal into the time-frequency domain. The hearing aid may comprise the memory unit.

The signal processor may be a computer chip constituting the hearing aid. The signal processor may be a part of the computer chip.

A processed audio signal may be based on one or more of the audio input signals. The signal processor may be configured to provide a plurality of processed audio signals. The signal processor may be configured to provide, based on a processing parameter, the processed audio signal by processing the audio input signal. The signal processor may be configured to process the audio input signal. Processing the audio input signal may include altering or modifying the audio input signal based on a processing parameter. For example, the signal processor may comprise one or more of the following: a beamformer, a single-channel filter, a neural network trained to extract speech from the audio input signals, a hearing loss compensation algorithm, compression, a feedback cancellation system and provide, based on the processing parameter and audio input signal, the processed audio signal. The signal processor may provide the processed audio signal based on a plurality of processing parameters.

The signal processor may comprise a noise reduction system configured to attenuate noise in the audio input signal. The audio input signal may comprise a desired speech and noise. The desired speech may be sound from a desired speaker in the sound environment. The noise may be additive noise such as sound from undesired sound sources, e.g., an undesired speaker in the sound environment. For example, the noise reduction system can be configured to attenuate noise in the audio input signal so that the sound quality and/or speech intelligibility may be perceived as improved compared to the audio input signals based on, e.g., a beamformer, a single-channel filter, a neural network trained to extract speech from the audio input signals, etc.

The signal processor may comprise a hearing loss compensation system configured to provide, based on the audio input signal, an amplified signal by amplification. Amplification may be considered providing the processed audio signal such that the energy of the processed audio signal is higher than the energy of the audio input signal. The signal processor may comprise a hearing loss compensation system configured to provide, based on the audio input signal, a compressed signal by compression. Compression may be considered as reducing the dynamic range. The dynamic range of a signal may be considered as the range of loudness of a signal. The signal processor may comprise a hearing loss compensation system configured to provide, based on the audio input signal, an amplified compressed signal by amplification and compression. For example, the hearing loss compensation system may be configured to provide, based on the audio input signal, the amplified compressed signal so that the speech intelligibility may be perceived as improved compared to the audio input signals. The amplification may be determined in dependence of an audiogram. The compression may be determined in dependence of an audiogram. An audiogram may be a graph that quantifies the auditory threshold across a range of frequencies. For example, the amount of allowed amplification in the hearing loss compensation system may be determined based on the audiogram.

An audiogram may be considered a hearing characteristics of a hearing aid user. The hearing characteristics may be an auditory threshold of the hearing aid user across a range of frequencies.

The processed audio signal may be characterized in that it contains less background noise compared to the audio input signals. The processed audio signal may be characterized in that it is amplified to compensate for a hearing loss. The degree of the hearing loss is being determined based on an audiogram of the hearing aid user.

A sub-band may be a frequency band and will in the present disclosure be used interchangeably.

The plurality of sub-band signals may be represented in the time-frequency domain or in the frequency domain. The plurality of sub-band signals may be the analysis filter bank output signal. The sub-band signals may be provided, based on the audio input signal, by an analysis filter bank. The sub-band signals may be the absolute square value of the analysis filter bank output signals. The sub-band signals may be based on the logarithmic value of the absolute square value of the analysis filter bank output signals.

The signal processor may comprise a signal path. The signal path may comprise a plurality of signal path signals. The signal path signals may be determined based on the audio input signals. The signal path signals may be the output of the analysis filter bank. The sub-band signals may be the signal path signals.

The signal processor may comprise a gain path. The gain path may comprise a plurality of gain path signals. The gain path signals may be determined based on the audio input signals. The gain path signals may be determined based on the signal path signals. The signal processor may comprise a frequency band-sum. The frequency band-sum may be configured to provide, based on the audio input signal, the gain path signals. The frequency band-sum may comprise a pre-determined band-sum mixer. The pre-determined band-sum mixer may be configured to provide the plurality of gain path signals by mixing (a linear combination or a linear transformation) the signal path signals. The mixing may comprise a plurality of pre-determined band-sum mixing weights. The pre-determined band-sum mixing weights may be pre-determined by a hearing aid developer. The gain path signal is in the time-frequency domain or in the frequency domain. The gain path signal comprises K₂ frequency bands. The number of frequency bands may be interpreted as the number of compression channels. The number of frequency bands may be interpreted as the number of noise reduction channels. The number of frequency bands in the gain path may be lower or equal to the number of frequency bands in the signal path, e.g., K₂≤K₁. The sub-band signals may be the gain path signals.

In an example embodiment, the signal processor comprises an analysis filter bank configured to provide, based on the audio input signal, a plurality of signal path signals in the time-frequency domain with K₁ number of frequency bands. The signal processor comprises a frequency band-sum configured to provide, based on the signal path signals, a plurality of gain path signals by applying a linear transformation on the signal path signals. The gain path signal is in the time-frequency domain with K₂ number of frequency bands such that K₂<K₁. The sub-band signals may be the gain path signals.

The sub-band combiner may comprise combining the sub-band combiner input signals. The sub-band combiner input signals may be the sub-band signals. The combination may be a linear combination, or a linear transform, or a mixing of the sub-band combiner input signals. The sub-band combiner may be configured to provide, based on the sub-band combiner input signals, a plurality of combined sub-band signals. The combined sub-band signals may be the combination of the sub-band combiner input signals. The sub-band combiner input signals may be the sub-band signals. The sub-band combiner input signals may be based on the sub-band signals. The sub-band combiner input signals may be based on the magnitude value of the sub-band signals. A magnitude value of the sub-band signals may be the absolute value of the sub-band signals. A magnitude value of the sub-band signals may be the absolute square value of the sub-band signals.

In an example embodiment, the sub-band combiner is configured to apply a linear transformation (e.g., configured to combine via a linear transformation). The linear transformation is configured to provide, based on the sub-band signals and a plurality of mixing weights, the combined sub-band signals. Each mixing weight may be considered a real-valued or complex valued value used for multiplication in the linear transformation. The mixing weights may be determined in dependence with a contextual parameter indicative of the sound environment. The mixing weights may be organized into a mixing matrix comprising the mixing weights without loss of generality. The mixing matrix may be a square matrix, i.e., an N×N matrix with identical number of row elements and column elements. A row element may be a part of the mixing weights or a part of the mixing matrix. A column element may be a part of the mixing weights or a part of the mixing matrix. An element of the mixing matrix may be one of the plurality of mixing weights. N may be the number of weights for each row or for each column. The mixing matrix may be a non-square matrix, i.e., an M×N matrix with identical number of row elements and column elements. M may be the number of column elements of the mixing matrix. N may be the number of row elements of the mixing matrix. The mixing matrix may be denoted as T(β) which may represent the mixing matrix is determined in dependence of the contextual parameter β. The linear transformation may be expressed as

$$y = T ( β ) x ,$$

where x may represent the sub-band combiner input signal vector. The sub-band combiner input signal vector may comprise the sub-band input signals. Each element of the sub-band input signal vector may be one of the sub-band input signals. y may represent the combined sub-band signal vector. The combined sub-band signal vector may comprise the combined sub-band signals. Each element of the combined sub-band signal vector may be one of the combined sub-band signals.

β may represent the contextual parameter. The contextual parameter β may be a numerical value. The expression T(β) may be understood as the mixing weights of the mixing matrix is a function of the contextual parameter β. The expression T(β) may be understood as the weights of the mixing matrix being dependent on the contextual parameter β. The expression T(β)x may denote the linear transformation.

In an example embodiment, the linear transformation for an N×N mixing matrix may be expressed as

$${y}_{n} = {\sum }_{m = 1}^{N} {t}_{n , m} ( β ) {x}_{m} , for n = 1 , … , N ,$$

where xₘ may represent one of the sub-band combiner input signals (e.g., the m'th sub-band combiner input signal). yₙ may represent one of the combined sub-band signals (e.g., the n'th combined sub-band signal). t_{n,m}(β) may represent the mixing weight of the n'th column and m'th row of the mixing matrix. The expression t_{n,m}(β) may be understood as the mixing weight of the n'th column and m'th row of the mixing matrix being a function of the contextual parameter β. The expression t_{n,m}(β) may be understood as the mixing weight of the n'th column and m'th row of the mixing matrix being determined in dependence with the contextual parameter β.

The plurality of sub-band combiner input signals may be the sub-band signals. The plurality of sub-band combiner input signals may be a plurality of pre-processed sub-band signals. A plurality of pre-processing sub-band signals may be understood as the sub-band signals having received (e.g., undergone) any modification. A modification may be considered as e.g., filtering, amplification, compression, computing the absolute value, computing the absolute square value, computing the logarithmic value of the absolute square value, etc.

The plurality of sub-band combiner input signals may be the signal path signals. The plurality of sub-band combiner input signals may be the gain path signals.

The plurality of combined sub-band signals may be provided by the sub-band combiner. The plurality of combined sub-band signals may be the output of the sub-band combiner. The plurality of combined sub-band signals may be in the gain path. The plurality of combined sub-band signals may be in the signal path.

The contextual parameter may be a value indicative of the sound environment. The contextual parameter may be a value indicative of a noise level of the sound environment. The contextual parameter may be a value indicative of a signal-to-noise ratio of the sound environment. The contextual parameter may be a value indicative of a speech activity of the sound environment. A speech activity may be considered as a probability of which a speech signal is present in the sound signal. A speech activity may be considered as if speech is detected (or not) based on the audio input signal. The contextual parameter may comprise a plurality of values indicative of the sound environment, e.g., a noise level and a signal-to-noise ratio, in any combination.

A processing parameter may be considered a parameter used to provide a processed audio signal. The signal processor may be configured to provide a plurality of processed audio signals. The processing parameter may comprise a real-valued number or a complex-valued number. The processing parameter may comprise a plurality of real-valued numbers or a plurality of complex valued numbers. The processing parameter may be a gain-value. The processing parameter may be a compression gain. The processing parameter may as a hearing loss compensation gain. The processing parameter may be a noise reduction gain. The processing parameter may be applied to the signal path signal to provide the processed audio signal. The processing parameter may be applied to the signal path signal as a multiplication. The processing parameter may be determined based on the combined sub-band signals. The processing parameter may be determined based on the combined sub-band signals in dependence with an audiogram. The processing parameter may be determined based on the combined sub-band signals in dependence with a gain-map. The gain map may be determined based on the audiogram. The gain map may be configured to be a gain as a function of a gain map input signal. The functional relation between the gain and the gain map input signal may be pre-determined by a hearing care professional or a hearing aid developer. The gain map input signal may be based on the combined sub-band input signal. The gain map may be configured to be a look-up table of gains as a function of a gain map input signal. The look-up table of gains as a function of a gain map input signal may be pre-determined by a hearing care professional or a hearing aid developer.

The signal processor may be configured to provide, based on a processing parameter for each frequency band in the gain path, K₂ number of gain values. The signal processor may be configured to provide, based on a processing parameter for each frequency band in the signal path, K₁ number of gain values. The signal processor may comprise a gain map for each frequency band in the gain path, e.g., K₂ number of gain values. The signal processor may comprise a gain map for each frequency band in the signal path, e.g., K₁ number of gain values.

In an example embodiment, the signal processor may be configured to determine a processing parameter for each frequency band in the gain path, i.e., K₂ number of processing parameters. Each processing parameter is determined based on a gain map for each (K₂) frequency band. The gain maps are in this embodiment pre-determined by a hearing care professional or a hearing aid developer. The gain maps are configured to receive the combined sub-band signals and provide a processing parameter for each frequency band in the gain path.

The processing parameter may be represented in the gain path. The processing parameter may be represented in the signal path. A plurality of processing parameters may be represented in the gain path by K₂ number of processing parameters. A plurality of processing parameters may be represented in the signal path by K₁ number of processing parameters.

The signal processor may comprise a frequency band-distributor. The frequency band-distributor may be the inverse of the frequency band-sum. The frequency band-distributor may be configured to provide, based on the processing parameters represented in the gain path, a processing parameter represented in the signal path. The frequency band-distributor may comprise a pre-determined distributor mixer. The frequency band-distributor may comprise a pre-determined distributor matrix. The pre-determined distributor mixer may be configured to provide a plurality of processing parameters represented in the signal path by mixing (e.g., by a linear combination or a linear transformation) the processing parameters represented in the gain path. The mixing may use a plurality of pre-determined distributor mixing weights. The pre-determined distributor mixing weights may be pre-determined by a hearing aid developer. The processing parameter represented in the signal path may be in the time-frequency domain or in the frequency domain. The processing parameter represented in the gain path or signal path may be a real-valued number or a complex valued number.

The signal processor may comprise a sound enhancer. The sound enhancer may be configured to provide, based on the audio input signal and the processing parameter, the processed audio signal. The sound enhancer may comprise a filter or a gain in the time-domain or frequency domain or time-frequency domain. The filter weights or the gain values may be the processing parameter. The processed audio signal being determined based on applying the filter weights or the gain values on the enhancer input signal. The enhancer input signal may be based on the audio input signal.

In an example embodiment, the signal processor is configured to determine a processing parameter (represented in the gain path) for each frequency band in the gain path, i.e., K₂ number of processing parameters. The signal processor comprises a frequency band-distributor comprising a plurality of pre-determined distributor mixing weights. The frequency band-distributor is configured to provide, based on the processing parameters represented in the gain path and the pre-determined distributor mixing weights, the processing parameters represented in the signal path. The signal processor is configured to provide, based on the processing parameter represented in the signal path, a processed audio signal by multiplying the processing parameters on the signal path signal.

An output unit may be configured to receive the processed audio signals. The output unit may be configured to provide, based on the processed audio signal, an auditory output signal. The auditory output signal can be based on the processed audio signal. An output signal may be represented as a time domain signal. An output signal may be represented as a frequency domain signal. An output signal may be represented as a time-frequency domain signal.

The output unit may comprise an output transducer. The output transducer may be a hearing aid receiver. The output transducer may be a loudspeaker. The output unit may comprise an amplifier configured to amplify the processed audio signal to a desired sound pressure level or a desired gain characteristics. The output unit may be configured to provide an auditory output sound. The auditory output sound may be a sound heard by a hearing aid user as provided by the hearing aid. The auditory output signal can be indicative of the sound environment.

The output unit may receive the processed audio signal as a digital signal. The output unit may be configured to convert processed audio signal into an analog signal. The conversion from a digital signal to an analog signal may be performed by a digital-to-analog converter (DAC). The DAC may be configured to receive a digital signal with a pre-defined amplitude and time resolution. The hearing aid may comprise the DAC. The hearing aid may comprise a plurality of DACs, so that each DAC is assigned to each processed audio signals.

The sub-band combiner may be configured to use a dependency parameter to combine the plurality of sub-band combiner input signals. The dependency parameter may be indicative of a dependency between the sub-band signals. The dependency parameter may be determined based on the contextual parameter.

An advantage of the present disclosure is a hearing aid is that the combination of the sub-band combiner input signals can be parameterized by a dependency parameter used to indicate the desired dependency between sub-band combiner input signals and later used to determine a processing parameter such as a compression gain or noise reduction gain to achieve an auditory output sound with improved sound quality and speech quality. However, as the dependency parameter is determined based on the contextual parameter which may be more indicative of the sound environment, the mapping from the contextual parameter to the dependency parameter is made more interpretable for hearing aid user, a hearing care professional, or a developer.

A dependency parameter may be defined as a parameter which determines a desired dependency between the sub-band combiner input signals. A dependency parameter may be defined as a parameter which determines a desired correlation between the combined sub-band signals and each sub-band combiner input signal. The dependency parameter may be indicative of a dependency between the sub-band signals, wherein the dependency may be a weighting. The dependency parameter may comprise a plurality of dependency parameters. The mixing weights used by the sub-band combiner may be determined based on the dependency parameter. The dependency parameter may be determined based on the contextual parameter. The dependency parameter may be determined based on a contextual model. The contextual model may be characterized by a functional relation between the dependency parameter and the contextual parameter. The functional relation may be used to determine the dependency parameter based on the contextual parameter.

The dependency parameter may be a value between ‘0’ and ‘1’ including ‘0’ and ‘1’.

The dependency parameter may be indicative of a desired dependency between the sub-band combiner input signals. The desired dependency may be pre-determined by a hearing care professional or a hearing aid developer. The desired dependency may be determined based on the contextual parameter.

The contextual parameter may be determined based on the audio input signal.

An advantage of the present disclosure is a hearing aid that automatically can determine the contextual parameter based on the audio input signal without interaction from the hearing aid user.

The contextual parameter may be determined based on a pre-processed audio input signal. The pre-processing may be performed by a noise reduction system. The sound signal may comprise a speech signal and background noise. The noise reduction system may be configured to attenuate background noise in the sound signal. The noise reduction system may be configured to attenuate background noise in the audio input signal. The noise reduction system may comprise filters, beamformers, neural networks trained to determine the speech signal. The noise reduction system may be configured to determine a sound characteristics. The sound characteristics may be a signal-to-noise ratio. The signal-to-noise ratio may be a value indicative of the ratio or difference between the target speech energy and the background noise energy. The sound characteristics may be a noise level. The noise level may be the energy of the background noise. The sound characteristics may be a voice activity value. The voice activity value may be a value between ‘0’ and ‘1’ (including ‘0’ and ‘1’) indicative of speech presence. Speech presence may be considered as the presence of the target speech signal in the audio input signal or pre-processed audio input signal. The contextual parameter may be determined based on an EEG signal. The EEG signal may be used to determine a cognitive load. The determined cognitive load may be indicative of the listening effort of a hearing aid user. The contextual parameter may be indicative of the listening effort. The contextual parameter may be indicative of the sound environment. The contextual parameter may be indicative of the noise field. The noise field may be considered as the distribution of noise sources in the sound environment. A noise sound may be considered as a sound source providing undesired sound in the sound environment.

The contextual parameter may be based on a narrow-band noise detector output signal. The narrow-band noise detector output signal may be determined by a narrow-band noise detector based on the audio input signal. The narrow-band noise detector may be configured to determine the presence of narrow-band noise. A narrow-band noise may be considered as noise dominant in a single frequency band. A narrow-band noise may be considered as noise dominant in a frequency band and the neighboring frequency bands. The narrow-band noise detector may determine the narrow-band noise detector output signal by determining a signal-to-noise ratio for each frequency band. The signal-to-noise ratio of neighboring frequency bands may be compared to determine the presence of a narrow-band noise. The comparison may be based on determining the difference or ratio between signal-to-noise ratio between neighboring frequency bands. The comparison may use a threshold, wherein if the difference or ratio is above or equal to the threshold the narrow-band noise detector output signal is indicative of narrow-band noise. If the difference or ratio is below the threshold the narrow-band noise detector output signal is indicative of no narrow-band noise. Alternatively, if the difference or ratio is below the threshold the narrow-band noise detector output signal is indicative of narrow-band noise. If the difference or ratio is above or equal the threshold the narrow-band noise detector output signal is indicative of no narrow-band noise

The contextual parameter may be one or more of following: a signal-to-noise ratio, a noise level, a voice activity value.

An advantage of the present disclosure is that the contextual parameter may be determined based on readily available parameters in most hearing aids. Thereby potentially saving computational complexity and power consumption.

The contextual parameter may be a signal-to-noise ratio.

The contextual parameter may be a voice activity value.

The contextual parameter may be a noise level.

The contextual parameter may be a combination of a signal-to-noise ratio, voice activity value, and a noise level. The contextual parameter may be a parameter based on a signal-to-noise ratio, voice activity value, and a noise level.

The sub-band combiner may be configured to provide, based on a plurality of mixing weights, the plurality of combined sub-band signals by mixing the sub-band combiner input signals. The mixing weights may be determined based on the dependency parameter.

An advantage of the present disclosure is the use of mixing to combine the sub-band combiner input signals. Mixing may be a computationally efficient method of combining the sub-band combiner input signals while creating a desired frequency dependency between frequency bands.

The mixing weights may be used by the sub-band combiner to combine the sub-band combiner input signals. The mixing weights may be determined based on the dependency parameter.

The mixing weights may be determined based on a sub-band dependency model. The sub-band dependency model may be indicative of a relation between the dependency parameter and the mixing weights.

An advantage of the present disclosure is the use of a sub-band dependency model to specify the mixing weights as a function of the dependency parameter. Thereby, an advantage is that the mixing weights may not need to be stored on a memory device on the hearing aid but may be determined online.

A sub-band dependency model may be a function indicative of the relation between mixing weights and the dependency parameter. A sub-band dependency model may be a look-up table indicative of the relation between mixing weights and the dependency parameter. The function may be based on the dependency model. The dependency model may be pre-determined by the hearing aid developer. The dependency model may provide a mathematical model of the functional relation between the mixing weights and the dependency parameter. A hearing aid developer may be considered as a developer developing the hearing aid. The sub-band dependency model may be denoted as f_{d}(α,n,m) such that

$${t}_{n , m} ( α ) = {f}_{d} ( α , n , m ) ,$$

Where α may represent the dependency parameter, n may represent the n'th column element of the mixing weight matrix, m may represent the m'th row element of the mixing matrix, and t_{n,m}(α) may represent the mixing weight of the n'th column element and m'th row element of the mixing matrix.

The relation between the dependency parameter and the mixing weights may be based on an exponential function.

An advantage of the present disclosure is that the sub-band dependency model is based on an exponential function which is parameterized with only one parameter, making it simple to modify the characteristics of the sub-band dependency model. Moreover, the exponential function may be configured to be exponentially decaying thus achieving a desired effect wherein the dependency between neighboring frequency is exponentially decaying.

The sub-band dependency model may be given by

$${t}_{n , m} = {f}_{d} ( α , n , m ) = {α}^{\vert n - m \vert} ,$$

where t_{n,m} may represent the mixing weight of the n'th column element and m'th row element of the mixing matrix. The function α^{|n-m|} may represent the exponential function, where the operator |⋅| refers to the absolute value of n−m. The sub-band dependency model may be given by

$${t}_{n , m} = {f}_{d} ( α , n , m ) = {f}_{c} {( β )}^{\vert n - m \vert} ,$$

Where β may be the contextual parameter and f_{c}(β)=α and f_{c}(β)∈[0,1], i.e. the numerical range of f_{c}(β) is between ‘0’ and ‘1’ including ‘0’ and ‘1’. The mixing matrix may be expressed as

$$T ( α ) = [ \begin{matrix}1 & α & {α}^{2} & {α}^{3} & {α}^{4} & … & {α}^{N - 1} \\ α & 1 & α & {α}^{2} & {α}^{3} & … & {α}^{N - 2} \\ {α}^{2} & α & 1 & α & {α}^{2} & … & {α}^{N - 3} \\ {α}^{3} & {α}^{2} & α & 1 & α & … & {α}^{N - 4} \\ ⋮ & ⋮ & ⋮ & ⋮ & ⋮ & … & ⋮ \\ {α}^{N - 1} & {α}^{N - 2} & {α}^{N - 3} & {α}^{N - 4} & {α}^{N - 5} & … & 1\end{matrix} ]$$

The combined sub-band signals may be determined based on:

$${y}_{n} = {\sum }_{m = 1}^{N} {α}^{\vert n - m \vert} \cdot {x}_{m} , for n = 1 , … , N .$$

The dependency parameter α may be chosen from a discrete set of values. The discrete set of values may be 0.5, 0.25, 0.125, 0.0625. The discrete set of values may be based on the base-2 exponent, i.e., 2^{q} for q∈ [symbol] where [symbol] represents the set of integer numbers including ‘0’. The dependency parameter may be a value of 0.7. The dependency parameter may be a value of 0. The dependency parameter may be a value of 1. The dependency parameter may be any value of 0, 0.1, 0.2, 0.3, 0.4, 0.5, 0.6, 0.7, 0.8, 0.9, 1.

The combined sub-band signals may be determined based on bit-shifting and mixing. The combined sub-band signals may be determined based on

$${y}_{n} = {\sum }_{m = 1}^{N} ( {x}_{m} ≫ \vert n - m \vert ) , for n = 1 , … , N ,$$

Where >> represents the logical right bit-shifting operator.

The signal processor may comprise a method for determining the equivalent number of frequency bands (e.g., compression channels) of the combined sub-band signal.

The sub-band combiner input signals may comprise N frequency bands. The frequency bands may be independent. Independence in this context may be understood as an insignificant statistical dependence between frequency bands. The sub-band combiner may provide the combined sub-band signals so that the N frequency bands of the combined sub-band signals become statistically dependent. Dependence in this context may be understood as significant statistical dependence between frequency bands. The effective number of independent frequency bands of the combined sub-band signals may be determined by:

$${N}_{eff} = N \frac{1 - α}{1 + α}$$

where N_{eff} is the effective number of independent frequency bands of the combined sub-band signal.

The signal processor may comprise an energy matcher. The energy matcher may be configured to provide, based on the plurality of combined sub-band signals, a plurality of energy-matched sub-band signals. The energy-matched sub-band signals and the plurality of sub-band combiner input signals may match in energy. The processing parameter is determined based on the energy-matched sub-band signals.

An advantage of the present disclosure is that the energy matcher normalizes the combined sub-band signals to match the energy of the sub-band combiner input signal, so that the determination of the processing parameter may be improved.

An energy matcher may be considered as matching the energy of the combined sub-band signals to the sub-band combiner input signal. The energy may be defined as the expected or average absolute square value. The energy may be defined as the expected or average absolute value. The energy may be represented in the logarithmic domain. The energy may be per frequency band. The energy may be across frequency bands. The matching may be considered as modifying the energy of the combined sub-band signals so that the energy corresponds to the energy of the sub-band combiner input signal. The sub-band combiner may comprise the energy matcher. The mixing weights may comprise the energy matcher. The mixing weights may be determined based on the energy matching. The energy matcher may comprise a constant value. The energy matcher may comprise an adaptive value. The energy matcher may comprise a pre-determined value. The energy matcher may comprise a value between 0 and 1 including ‘0’ and ‘1’.

In an example embodiment, the energy matcher may comprise a pre-determined value constituting the mixing weights. The pre-determined value is denoted as c. The combined sub-band signals may be denoted as

$${y}_{n} = {\sum }_{m = 1}^{N} {\tilde{t}}_{n , m} {x}_{m} , for n = 1 , … , N ,$$

where \tilde{t}_{n,m}=c·t_{n,m} where t_{n,m} is the n'th and m'th mixing weight of the mixing matrix and \tilde{t}_{n,m} is the mixing weight comprising the energy matching.

The energy matcher may be configured to provide the energy-matched sub-band signals based on a matching parameter. The matching parameter may be determined based on the dependency parameter. The energy matcher may be configured to energy match the combined sub-band signals based on the matching parameter.

An advantage of the present disclosure is that the matching parameter is dependent on the dependency parameter so that when the mixing weights change. This is advantageous since the energy compensation needed to match the sub-band combiner input signals with the combined sub-band signals changes according to the dependency parameter. Hence, the energy matcher need to be dependent on the dependency parameter as well.

The matching parameter may comprise a constant value. The matching parameter may comprise an adaptive value. The matching parameter may comprise a pre-determined value. The matching parameter may comprise a value between 0 and 1 including ‘0’ and ‘1’.

Energy matching the combined sub-band signals with the sub-band combiner input signal may be based on the matching parameter. The energy matching may be performed by multiplying the matching parameter on the combined sub-band signal. The energy matching may be determined by multiplying the matching parameter on the sub-band combiner input signal. The energy matching may be determined as

$${c}_{n} = {\sum }_{m = 1}^{N} {t}_{n , m}$$

where cₙ represents the matching parameter of the n'th frequency band. In an example embodiment, the matching parameter may be determined as

$${c}_{n} = {\sum }_{m = 1}^{N} {α}^{\vert n - m \vert}$$

where α is pre-determined to be a value between ‘0’ and ‘1’ including ‘0’ and ‘1’.

The dependency parameter may be determined based on a contextual model. The contextual model may be indicative of a relation between the contextual parameter and dependency parameter.

A contextual model may be a function indicative of the relation between dependency parameter and the contextual parameter. The contextual model may be a look-up table indicative of the relation between dependency parameter and the contextual parameter. The function may be based on the contextual model. The contextual model may be pre-determined by the hearing aid developer. The contextual model may provide a mathematical model of the functional relation between the dependency parameter and the contextual parameter. The contextual model may be denoted as f_{d}(α,n,m) such that

$$α = {f}_{c} ( β ) ,$$

Where β may represent the contextual parameter.

The relation between the contextual parameter and dependency parameter may be based on an affine model or a sigmoid model.

An advantage of using an affine model or a sigmoid model is that many perceptual models specifying the relation between the contextual parameter and the dependency parameter often follow a sigmoid function or an approximation, e.g., a piecewise affine function.

The relation between the contextual parameter and dependency parameter may be based on an affine model. An affine model may comprise an affine function. The affine function may be modeled as

$$α = {f}_{c} ( β ) = {a}_{1} \cdot β + {a}_{2} ,$$

where a₁ is a real-value determining the slope and a₂ is a real-value determining the bias or off-set. The parameters a₁ and a₂ may be pre-determined parameters by a hearing care professional or a hearing aid developer. The affine model may comprise a plurality of affine functions. The affine model may comprise a linear function. The affine model may comprise a plurality of linear functions. The affine model may comprise a plurality of piecewise affine functions or linear functions. The affine model may comprise a minimum function. The affine model may comprise a maximum function. The maximum function may be defined as

$$max ( {q}_{1} , {q}_{2} ) ,$$

where q₁ and q₂ are real-valued. The maximum function returns the largest value amongst q₁ or q₂. The minimum function may be defined as

$$min ( {q}_{1} , {q}_{2} ) ,$$

where q₁ and q₂ are real-valued. The minimum function returns the smallest value amongst q₁ or q₂. The affine model may comprise a combination of affine functions, linear functions, minimum functions, and maximum functions.

In an example embodiment, the relation between the contextual parameter and dependency parameter may be based on an affine model. The affine model is a combination of an affine function, a minimum function, and a maximum function. The affine model may be expressed as

$$α = {f}_{c} ( β ) = min ( {p}_{2} , max ( {p}_{1} , {a}_{1} \cdot β + {a}_{2} ) ) ,$$

where p₁, p₂, a₁, and a₂ may be pre-determined parameters determined by a hearing care professional or a hearing aid developer. The inner term a₁·β+a₂ is an affine function parameterized by a₁ and a₂. The intermediate term max(p₁, a₁·β+a₂) selects the largest value amongst p₁ and a₁·β+a₂. The outer term min(p₂, max(p₁, a₁·β+a₂)) selects the smallest value amongst p₂ and max(p₁, a₁·β+a₂). In an example embodiment, p₁ may be a value of 0. In an example embodiment, p₁ may be a value between 0.3 and 1. In an example embodiment, pt may be a value of 0.7.

The relation between the contextual parameter and dependency parameter may be based on a sigmoid model. The sigmoid model may be based on the sigmoid function. The sigmoid model may be based on the logistic function. The sigmoid model may be based on the generalized logistic function.

The relation between the contextual parameter and dependency parameter may be based on a logistic function that may be expressed as

$$\frac{{d}_{1}}{1 + {e}^{- k ( β - {β}_{0} )}} ,$$

where d₁ is a value larger than ‘0’ and may be the maximum value of the logistic function, k is a real-value and may the determine the steepness of the logistic function, and β₀ is the midpoint of the logistic function. The parameters d₁, k, and β₀ may be pre-determined parameters determined by a hearing care professional or a hearing aid developer.

In an example embodiment, the relation between the contextual parameter and dependency parameter may be based on a logistic function. The parameters are chosen to d₁=0.7, k=0.5, and β₀=7.5. However, the parameters may in other embodiments be chosen differently depending on the preference of the hearing care professional or the hearing aid developer. The the relation between the contextual parameter and dependency parameter may in this embodiment be given as

$$α = {f}_{c} ( β ) = \frac{0.7}{1 + {e}^{- ( β - 7.5 )}} .$$

The dependency parameter may be determined based on the relation between the contextual parameter and dependency parameter.

The relation between the contextual parameter and dependency parameter may be based on a contextual perceptual model.

A contextual perceptual model may be based on a perceptual standard. The perceptual standard may be related to the degree of preferable compression of a hearing aid user or humans. The perceptual standard may be related to a speech intelligibility value. The speech intelligibility value may be a value related to the speech understand. The perceptual standard may be the standard ANSI S3.5. The contextual perceptual model may be a linear model or sigmoid model wherein the pre-determined parameters of the linear model or the sigmoid model are fitted based on the ANSI S3.5 standard.

In an embodiment, the contextual parameter is a signal-to-noise ratio (SNR) value. If the SNR is low, e.g., 0 dB SNR, the number of effective frequency bands of the combined sub-band signals is maximized. If the SNR is high, e.g., 15 dB SNR, the number of effective frequency bands of the combined sub-band signals is targeted to be 4. If the SNR is between the low and high range, the number of effective frequency bands is chosen to be between 4 and the maximum number of frequency bands.

In an embodiment, the contextual parameter is a signal-to-noise ratio (SNR) value. If the SNR value is 0 dB, the number of effective frequency bands of the combined sub-band signals is K₂, i.e., the number of frequency bands in the gain path. If the SNR value is 15 dB, the number of effective frequency bands of the combined sub-band signals is 4. If the SNR value is between the low and high range, the number of effective frequency bands is chosen based on a linear model. The contextual perceptual model may be expressed as

$$α = {f}_{c} ( β ) = min ( 15 , max ( 0 , 7.5 \cdot β ) ) .$$

The signal processor may comprise a level estimator. The level estimator may be configured to provide, based on the sub-band signals, the plurality of sub-band combiner input signals. The sub-band combiner input signals may be indicative of an energy of the sub-band signals.

A level estimator may be considered as an estimator configured to estimate the level of each sub-band combiner input signal. The level estimator may be considered as an estimator configured to estimate the total level of the sub-band combiner input signals across frequency bands. The level may be an energy of the sub-band combiner input signal. The level may be determined as the absolute-square value of the sub-band signals. The level may be determined as the absolute value of the sub-band signals. The level may be represented in the logarithmic domain. The level estimator may be configured to smoothen the estimated levels. The smoothing may be determined based on low-pass filtering. The total level of the sub-band combiner input signals across frequency bands may be determined as the average level of sub-band combiner input signals across frequency bands.

The sub-band combiner input signals may be the estimated levels of the sub-band signals.

The processing parameter may be determined based on the combined sub-band signals and a gain map. The gain map may be indicative of a relation between the combined sub-band signals and the processing parameter in dependence of an audiogram.

An advantage of the present disclosure is that the processing parameter being determined in dependence of an audiogram.

Determining the processing parameter may be based on the combined sub-band signals and in dependence of an audiogram and a gain map. The gain map may be a look-up table. The look-up table may be determined based on the audiogram. The gain map characteristics may be determined based on the audiogram. The gain map may be a compression curve. The gain map characteristics may be the compression curve characteristics. The compression curve characteristics may comprise the slopes, the knee points, and the midpoints of the knee points. The compression curve being determined based on the audiogram. The compression curve is indicative of at least one gain value as a function of the combined sub-band signals.

The signal processor may comprise a plurality of gain maps. A gain map may be associated with each frequency band. The gain map may be configured to provide, for each combined sub-band signal, a processing parameter. The processing parameters may be the at least one gain value.

The relation between the combined sub-band signals and the processing parameter may be the compression curve.

The signal processor may comprise a hearing loss compensator. The hearing loss compensator may be configured to provide, based on the sub-band signals and the processing parameter, the processed audio signal.

The hearing aid may comprise a microphone. The microphone may be configured to pick up audio from a sound environment. The sound signal may be the picked-up audio.

In one or more example hearing aids, a hearing aid comprises an input unit. The input unit is configured to provide an audio input signal based on a sound signal. The sound signal is indicative of a sound environment. The hearing aid comprises a signal processor. The signal processor is configured to determine a plurality of sub-band signals based on the audio input signal. The signal processor comprises a sub-band combiner. The sub-band combiner is configured to combine a plurality of sub-band combiner input signals based on the sub-band signals. The sub-band combiner is configured to determine a plurality of combined sub-band signals based on a contextual parameter. The signal processor is configured to provide a processed audio signal based on the audio input signal and a processing parameter. The processing parameter is determined based on the combined sub-band signals. The processing parameter is determined in dependency of a signal-to-noise ratio value. The processing parameter may be determined in dependency of an audiogram. The hearing aid comprises an output unit. The output unit is configured to receive the processed audio signal. The output unit is configured to provide, based on the processed audio signal, an auditory output sound. The auditory output sound is indicative of the sound signal.

The signal processor may comprise a voice activity detector configured to detect, based on the audio input signal, the presence of audio input signal, and provide a voice activity detector output 501 indicative of speech activity in audio input signal. The voice activity detector may be configured to provide, based on the audio input signal, an estimate of the signal-to-noise ratio 501. The voice activity detector may be configured to provide, based on the estimated signal-to-noise ratio, an estimate of a global signal-to-noise ratio. The global signal-to-noise ratio may be indicative of the average signal-to-noise ratio across frequency bands.

The signal processor may include a beamforming system. The beamforming system may comprise a plurality of beamformers. The beamformers may be adaptive beamformers configured to adapt to the background noise based on the voice activity detector output. The beamformers may be configured to determine a noise statistic such that when speech is absent, the adaptive beamformers determines the noise statistics. The adaptive beamformers may be configured to reduce the background noise while preserving a desired speech signal based on the determined noise statistics. The desired speech signal may constitute a part of the audio input signal, which comprises a speech signal, the hearing aid user may want presented. The beamforming system may be configured to provide a beamformed signal. The adaptive beamformers may be configured to provide a noise signal based on the audio input signal and the determined noise statistics. The noise signal may be indicative of the background noise.

The signal processor may comprise a first level estimator. The first level estimator may be configured to provide, based on the beamformed signals, a plurality of first sub-band combiner input signals. The first sub-band combiner input signals may be determined by first computing the absolute-square value of the beamformed signals to provide a plurality of beamformed absolute-squared signals and second low-pass filtering the beamformed absolute-squared signals.

The signal processor may comprise a second level estimator. The second level estimator may be configured to provide, based on the noise signals, a plurality of second sub-band combiner input signals. The second sub-band combiner input signals may be determined by first computing the absolute-square value of the noise signals to provide a plurality of noise absolute-squared signals and second low-pass filtering the noise absolute-squared signals. The signal processor may comprise a first sub-band combiner. The first sub-band combiner may be configured to receive the mixing matrix, i.e., the mixing weights, and the first sub-band combiner input signals. The first sub-band combiner may be configured to provide, based on the mixing matrix and the first sub-band combiner input signals, a plurality of first combined sub-band signals by a linear transformation.

The signal processor may comprise a second sub-band combiner. The second sub-band combiner may be configured to receive the mixing matrix, i.e., the mixing weights, and the second sub-band combiner input signals. The second sub-band combiner may be configured to provide, based on the mixing matrix and the second sub-band combiner input signals, a plurality of second combined sub-band signals by a linear transformation.

The signal processor may comprise a local signal-to-noise ratio estimator. The local signal-to-noise ratio may be configured to receive the first combined sub-band signals and the second combined sub-band signals. The local signal-to-noise ratio may be configured to provide an estimate of a local signal-to-noise ratio value for each frequency band, based on the first combined sub-band signals and the second combined sub-band signals. The local signal-to-noise ratio value may be determined as the ratio between the first combined sub-band signals and the second combined sub-band signals.

The signal processor may comprise a post-filter. The post-filter may comprise a Wiener filter. The post-filter may be configured to receive the estimated local signal-to-noise ratio value, and the beamformed signal-to-noise. The post filter may be configured to determine a post-filter gain for each frequency band based on the local signal-to-noise ratio value. The post-filter gain may be expressed as

$${g}_{n} = \frac{ξ}{1 + ξ}$$

where ξ represents the estimated local signal-to-noise ratio, and gₙ represents the post-filter gain. The post-filter may be configured to provide a plurality of enhanced signals. The enhanced signals may be determined as

$${s}_{n} = {g}_{n} \cdot {b}_{n} ,$$

where bₙ represents the beamformed signals of the n'th frequency band, and sₙ represents the enhanced signals of the n'th frequency band.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may comprise a number of electrodes of a cochlear implant (for a CI type hearing aid) or a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g., a microphone, for converting an input sound to an electric input signal. The input unit may comprise a wireless receiver for receiving a wireless signal comprising or representing sound and for providing an electric input signal representing said sound.

The wireless receiver and/or transmitter may e.g., be configured to receive and/or transmit an electromagnetic signal in the radio frequency range (3 kHz to 300 GHz). The wireless receiver and/or transmitter may e.g., be configured to receive and/or transmit an electromagnetic signal in a frequency range of light (e.g., infrared light 300 GHz to 430 THz, or visible light, e.g., 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g., described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g., a distance d_{mic} between two microphones of a directional system. A typical microphone distance in a hearing aid is of the order 10 mm. A minimum distance of a sound source of interest to the user (e.g., sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g., the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g., a TV-set), a communication device (e.g., a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g., an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g., hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time to (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g., 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g., from an input transducer, such as a microphone) with a predefined sampling rate, e.g., 20 kHz. The hearing aids may comprise a digital-to-analogue (DA) converter to convert a digital signal to an analogue output signal, e.g., for being presented to a user via an output transducer.

The hearing aid, e.g., the input unit, and or the antenna and transceiver circuitry may comprise a transform unit for converting a time domain signal to a signal in the transform domain (e.g., frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g., a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g., a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g., increasing in width with frequency), overlapping or non-overlapping.

The hearing aid may be configured to operate in different modes, e.g., a normal mode and one or more specific modes, e.g., selectable by a user, or automatically selectable. A mode of operation may be optimized to a specific acoustic situation or environment, e.g., a communication mode, such as a telephone mode. A mode of operation may include a low-power mode, where functionality of the hearing aid is reduced (e.g., to save power), e.g., to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g., singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g., an acceleration sensor. The movement detector may be configured to detect movement of the user's facial muscles and/or bones, e.g., due to speech or chewing (e.g., jaw movement) and to provide a detector signal indicative thereof.

The hearing aid may comprise a classification unit configured to classify the current situation based on input signals from (at least some of) the detectors, and possibly other inputs as well.

In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a recurrent neural network, e.g. a trained neural network.

The hearing aid may comprise an acoustic (and/or mechanical) feedback control (e.g., suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing aid system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

### A Method:

In another aspect, a method for providing an auditory output sound comprises. Receiving, by an input unit, a sound signal. Providing, by an input unit, an audio input signal indicative of sound. Providing, by a signal processor, a plurality of sub-band signals based on the audio input signal. Combining, by the signal processor comprising a sub-band combiner, a plurality of sub-band combiner input signals based on the sub-band signals. Providing, by the sub-band combiner, a plurality of combined sub-band signals based on a contextual parameter. Determining, by the signal processor, a processing parameter based on the combined sub-band signals. Providing, by the signal processor and based on the processing parameter, a processed audio signal based on the audio input signal. Providing, by an output unit, an auditory output sound based on the processed audio signal, wherein the auditory output sound is indicative of the sound environment.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

### A Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g., in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Hearing Aid System:

In a further aspect, a hearing aid system comprising a hearing aid as described above, in the ‘detailed description of embodiments’, and in the claims, AND an auxiliary device is moreover provided.

The hearing aid system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing aid system may comprise two hearing aids adapted to implement a binaural hearing system, e.g. a binaural hearing aid system.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows an example embodiment of a hearing aid according to the present disclosure.

FIG. 2 schematically shows a detailed example embodiment of a hearing aid according to the present disclosure.

FIG. 3 illustrates an example embodiment of a mixing matrix of the sub-band combiner according to the present disclosure.

FIG. 4A illustrates an example embodiment of a contextual model according to the present disclosure; and

FIG. 4B illustrates an example embodiment of a contextual model according to the present disclosure.

FIG. 5 schematically shows a detailed example embodiment of a hearing aid according to the present disclosure.

FIG. 6 schematically shows an example embodiment of a method for providing an auditory output sound according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon a particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

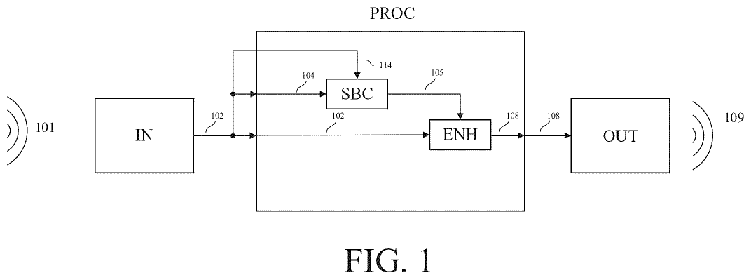

FIG. 1 shows an exemplary block diagram of an example hearing aid according to the present disclosure. The hearing aid comprises an input unit IN, a signal processor PROC, and an output unit OUT. The input unit is configured to provide an audio input signal 102 based on a picked-up sound signal from the sound environment 101. The signal processor PROC comprises a sub-band combiner SBC and a sound enhancer ENH. The signal processor PROC is configured to provide, based on the audio input signal 102, a sub-band signal 104. The signal processor PROC is configured to provide, based on an estimated of a signal-to-noise ratio (SNR) based on the audio input signal 102, a contextual parameter 114. The contextual parameter 114 is used by the signal processor PROC to determine a plurality of mixing weights. The sub-band combiner SBC is configured provide, based on the sub-band signals 104 and the mixing weights 106, a plurality of combined sub-band signals 105. The sound enhancer ENH is configured to provide, based on the combined sub-band signals 105, a processed audio signal 108. The output unit OUT is configured to receive the processed audio signal 108 and provide an auditory output signal 108.

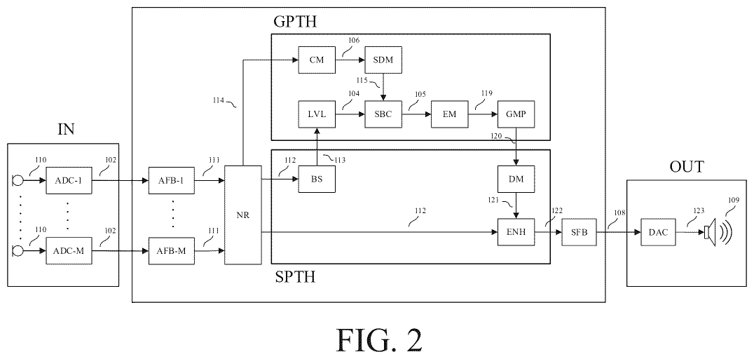

FIG. 2 shows a detailed exemplary block diagram of an example hearing aid according to the present disclosure. The hearing aid comprises an input unit IN, a signal processor PROC, and an output unit OUT. The input unit IN is configured to provide an audio input signal 102 based on a picked-up sound signal from the sound environment. The hearing aid HA comprises an input unit IN comprising a plurality of microphones. The microphones are configured to provide an analog audio input signal 110.

The input unit IN comprises an analog-to-digital converter ADC-1, . . . , ADC-M for each analog audio input signal 110. The analog-to-digital converters analog-to-digital ADC-1, . . . , ADC-M are configured to convert the analog audio input signals 110 to digital audio input signals 102 with a pre-defined sampling rate and bit-resolution. The digital input signals 102 are signals represented in the time-domain. The input unit IN provides the audio input signals 102 based on the digital audio input signals 102.

The signal processor PROC comprises an analysis filter bank AFB-1, . . . , AFB-M for each audio input signal 102. The analysis filter banks AFB-1, . . . , AFB-M are configured to transform the audio input signals 102 into the time-frequency domain from the time domain with a frequency band resolution K₁ and a frame rate F_{S}. The analysis filter banks AFB-1, . . . , AFB-M provide a plurality of time-frequency domain audio input signals 111.

The signal processor PROC comprises a noise reduction system NR. The noise reduction system NR is configured to provide, based on the audio input signals 102, an enhanced signal 112. The noise reduction system NR comprises an adaptive beamformer and post-filter configured to provide the enhanced signal 112 by attenuating background noise in the sound environment represented in the audio input signal 111. The noise reduction system NR is further configured to provide an estimate of a global signal-to-noise ratio 114 of the enhanced signal measured in decibels (dB). The global SNR 114 being indicative of the signal-to-noise ratio across frequency bands by determining the average signal-to-noise ratio over frequency bands.

In certain embodiments, the signal processor PROC comprises a signal path SPTH and a gain path GPTH. The signal path SPTH comprises a frequency band-sum BS configured to mix, based on a plurality of frequency band-sum mixing weights, the enhanced signal 112 by a linear transformation. The frequency band-sum mixing weights are pre-determined by a hearing aid developer. The frequency band-sum BS is configured to provide, based on the enhanced signal 112, a plurality of gain path enhanced signals 113. The gain path enhanced signals 113 are represented in the time-frequency domain with K₂ number of frequency bands, where K₂<K₁.

The gain path GPTH comprises a contextual model CM configured to receive the global SNR 114. The contextual model CM comprises a plurality of linear functions configured to provide a dependency parameter 106. The relation between the global SNR 114 and the dependency parameter 106 may be expressed as

$$α = {f}_{c} ( β ) = min ( {p}_{2} , max ( {p}_{1} , {a}_{1} \cdot β + {a}_{2} ) ) ,$$

where p₁, p₂, a₁, and a₂ are pre-determined parameters determined by a hearing aid developer, and β is the global SNR 114, and α is the dependency parameter 106.

The gain path GPTH comprises a sub-band dependency model SDM configured to receive the dependency parameter 106. The contextual model CM comprises an exponential function configured to provide a plurality of mixing weights 115. In certain embodiments, the relation between the dependency parameter 106 and the mixing weights 115 may be expressed as

$${t}_{n , m} = {α}^{\vert n - m \vert} ,$$

where t_{n,m} represents the mixing weight of the n'th column element and m'th row element of a mixing matrix. The mixing matrix may be expressed as

$$T ( α ) = [ \begin{matrix}1 & α & {α}^{2} & {α}^{3} & {α}^{4} & … & {α}^{N - 1} \\ α & 1 & α & {α}^{2} & {α}^{3} & … & {α}^{N - 2} \\ {α}^{2} & α & 1 & α & {α}^{2} & … & {α}^{N - 3} \\ {α}^{3} & {α}^{2} & α & 1 & α & … & {α}^{N - 4} \\ ⋮ & ⋮ & ⋮ & ⋮ & ⋮ & … & ⋮ \\ {α}^{N - 1} & {α}^{N - 2} & {α}^{N - 3} & {α}^{N - 4} & {α}^{N - 5} & … & 1\end{matrix} ] ,$$

where the element of the first column first row of the mixing matrix corresponds to t_{1,1}, and the element of the first column second row of the mixing matrix corresponds to t_{2,1}, and the element of the second column second row of the mixing matrix corresponds to t_{2,2}. The sub-band dependency model SDM is configured to provide the mixing matrix 106.

The signal processor PROC comprises a level estimator LVL. The level estimator is configured to provide, based on the gain path enhanced signals 113, a plurality of sub-band combiner input signals 104. The sub-band combiner input signals 104 are determined by first computing the absolute-square value of the gain path enhanced signals 113 to provide a plurality of gain path enhanced absolute-squared signals and second low-pass filtering the gain path enhanced absolute-squared signals.

The signal processor PROC comprises a sub-band combiner SBC. The sub-band combiner is configured to receive the mixing matrix 115, i.e., the mixing weights 115, and the sub-band combiner input signals 104. The sub-band combiner SBC is configured to provide, based on the mixing matrix 115 and the sub-band combiner input signals 104, a plurality of combined sub-band signals 105 by a linear transformation. The combined sub-band signals 105 may be expressed as

$${y}_{n} = {\sum }_{m = 1}^{{K}_{2}} {t}_{n , m} \cdot {x}_{m} , for n = 1 , … , N ,$$

where xₘ represents the sub-band combiner input signal 104 of the m'th frequency band of the gain path GPTH (the gain path GPTH having K₂ frequency bands), and yₙ represents the combined sub-band signal 105 of the n'th frequency band of the gain path GPTH.

The gain path GPTH comprises an energy matcher EM configured to receive the combined sub-band signal 105. The energy matcher EM is configured to match the energy of the combined sub-band signals 105 to the energy of the sub-band combiner input signals 104 based on a matching parameter. In certain embodiments, the matching parameter is determined based on the dependency parameter 106, and determining the matching parameter can be expressed as

$${c}_{n} = {\sum }_{m = 1}^{N} {α}^{\vert n - m \vert} ,$$

where c represents the matching parameter. The energy matcher EM is configured to provide a plurality of energy matched combined sub-band signal 119. The energy matched combined sub-band signals 119 can be expressed as

$${\tilde{y}}_{n} = {y}_{n} \cdot {c}_{n} ,$$

where \tilde{y}ₙ represents the energy matched combined sub-band signal 119 of the n'th frequency band.

The gain path GPTH comprises a plurality of gain maps GMP. Each gain map GMP comprises a compression curve determined based on an audiogram of a hearing aid user. The compression curve is pre-determined by a hearing care professional or a hearing aid developer. The gain map GMP is configured to receive the plurality of energy matched combined sub-band signals 119. The gain map GMP is configured to provide, based on the plurality of energy matched combined sub-band signals 119 and the compression curves, a plurality of gain path processing parameters 120.

The signal path SPTH comprises a frequency band distributor DM configured to receive the gain path processing parameters 120. The frequency band distributor DM is configured to use a distributor matrix configured to mix the gain path processing parameters 120 by a linear transformation based on a distributor matrix comprising a plurality of distributor mixing weights. The distributor mixing weights are pre-determined by a hearing aid developer. The frequency band distributor DM is configured to provide, based on the gain path processing parameters 120, a plurality of signal path processing parameters 121 (i.e. K₁ number of signal path processing parameters).

The signal path SPTH comprises a sound enhancer ENH configured to receive the enhanced signals 112 and the signal path processing parameters 121. The sound enhancer ENH is configured to provide a plurality of sound enhanced signals 122 by applying the signal path processing parameters 121 on the enhanced signals 112 which can be expressed as

$${s}_{l} = {g}_{l} \cdot {z}_{l} ,$$

where zₗ represents the enhanced signal 112 of the l'th frequency band in the signal path SPTH (i.e. the signal path SPTH having K₁ frequency bands), gₗ represents in the signal path processing parameter 121 of the l'th frequency band in the signal path SPTH, and sₗ represents in the sound enhanced signals 122 of the l'th frequency band in the signal path SPTH.

The signal processor PROC comprises a synthesis filter bank SFB configured to transform the sound enhanced signal 122 from the time-frequency domain to the time domain. The synthesis filter bank SFB provides, based on the time domain sound enhanced signal 122, a processed audio signal 108.

The hearing aid comprises an output unit OUT configured to receive the processed audio signal 108. The output unit OUT comprises a digital-to-analog converter DAC configured to convert the processed audio signal 108 from a digital signal to an analog signal and provide an analog processed audio signal 123. The output unit OUT comprises a loudspeaker configured to provide, based on the analog processed audio signal 123, an auditory output sound 109 being heard by the hearing aid user.

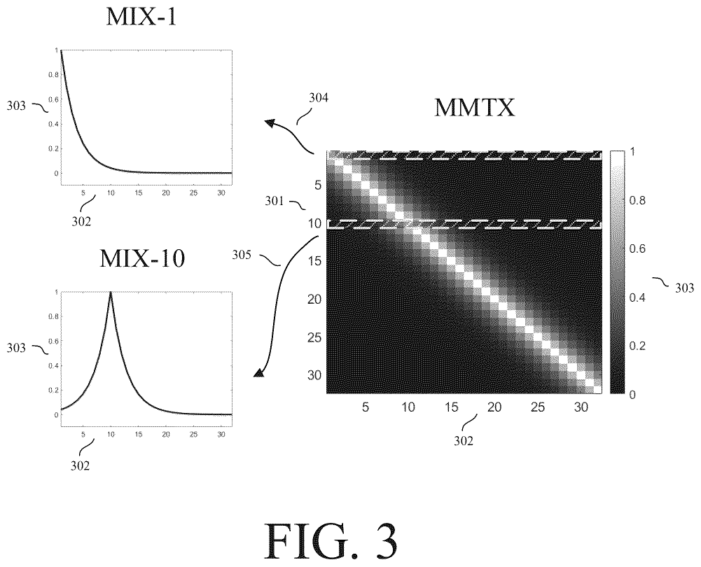

FIG. 3 illustrates an example embodiment of a mixing matrix of the sub-band combiner according to the present disclosure. The illustration in MMTX is an image generated based on an exemplary mixing matrix, where the mixing weights of the mixing matrix are determined based on a sub-band dependency model comprising an exponential function. The dependency parameter α used to determine the mixing matrix, is pre-determined to be α=0.7 as an example for this embodiment. The sub-band dependency model SDM may be expressed as

$${t}_{n , m} = {α}^{\vert n - m \vert} ,$$

where t_{n,m} represents the mixing weight of the n'th column element and m'th row element of a mixing matrix. The mixing matrix may be expressed as

$$T ( α ) = [ \begin{matrix}1 & α & {α}^{2} & {α}^{3} & {α}^{4} & … & {α}^{N - 1} \\ α & 1 & α & {α}^{2} & {α}^{3} & … & {α}^{N - 2} \\ {α}^{2} & α & 1 & α & {α}^{2} & … & {α}^{N - 3} \\ {α}^{3} & {α}^{2} & α & 1 & α & … & {α}^{N - 4} \\ ⋮ & ⋮ & ⋮ & ⋮ & ⋮ & … & ⋮ \\ {α}^{N - 1} & {α}^{N - 2} & {α}^{N - 3} & {α}^{N - 4} & {α}^{N - 5} & … & 1\end{matrix} ]$$

Each pixel of the image MMTX corresponds to one of the mixing weights of the mixing matrix. The top-left corner value of the mixing matrix corresponds to the top-left corner pixel of the image MMTX, and arrangement of pixels of the image MMTX is identical to the arrangement of values of the mixing matrix. The greyscale of the image MMTX is scaled to match the numerical size of the mixing weights, e.g., most white corresponds to a mixing value of ‘1’, and most dark corresponds to a mixing value of ‘0’. The horizontal axis of the image MMTX corresponds to the frequency band indices of the sub-band combiner input signals 104. The vertical axis of the image MMTX corresponds to the frequency band indices of the combined sub-band signals.

The images MIX-1 and MIX-10 are cross sections of the image MMTX plotted on a two-dimensional plot. The image MIX-1 is the first cross section 304 of the image MMTX of the first row of pixels. The first row of pixels is mapped into a plot showing the mixing weights of the first row as a function of frequency band of the sub-band combiner input signal. The image MIX-10 is the second cross section 305 of the image MMTX of the tenth row of pixels. The tenth row of pixels are mapped into a plot showing the mixing weights of the tenth row as a function of frequency band of the sub-band combiner input signal.

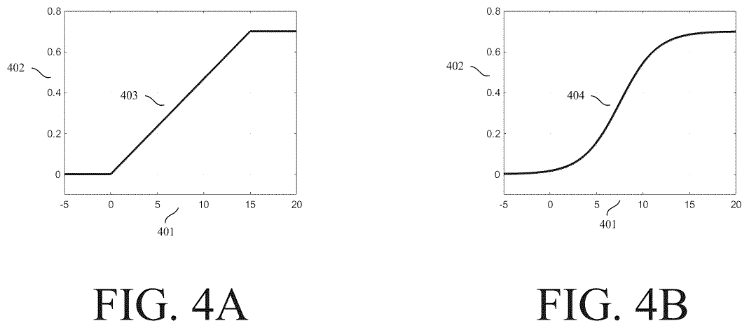

FIG. 4A illustrates an example embodiment of a contextual model according to the present disclosure. The contextual model comprises three piecewise linear functions. The contextual model provides a dependency parameter as a function of a contextual parameter. The dependency parameter is this embodiment denoted as a and is used for a sub-band dependency model SDM comprising an exponential function. The contextual parameter is a signal-to-noise ratio measured in dB. The horizontal axis 401 relates to the signal-to-noise ratio. The vertical axis 402 relates to the dependency parameter. In certain embodiments, the curve of the contextual model 403 may be expressed as

$$α = min ( 15 , max ( 0 , 0.046 β ) ) ,$$

where β represents the signal-to-noise ratio in dB.

FIG. 4B illustrates an example embodiment of a contextual model according to the present disclosure. The contextual model comprises a logistic function. The contextual model provides a dependency parameter as a function of a contextual parameter. The dependency parameter is this embodiment denoted as a and is used for a sub-band dependency model SDM comprising an exponential function. The contextual parameter is a signal-to-noise ratio measured in dB. The horizontal axis 401 relates to the signal-to-noise ratio. The vertical axis 402 relates to the dependency parameter. In certain embodiments, the curve of the contextual model 404 may be expressed as

$$α = \frac{0.7}{1 + {e}^{- ( β - 7.5 )}} ,$$

where β represents the signal-to-noise ratio in dB.

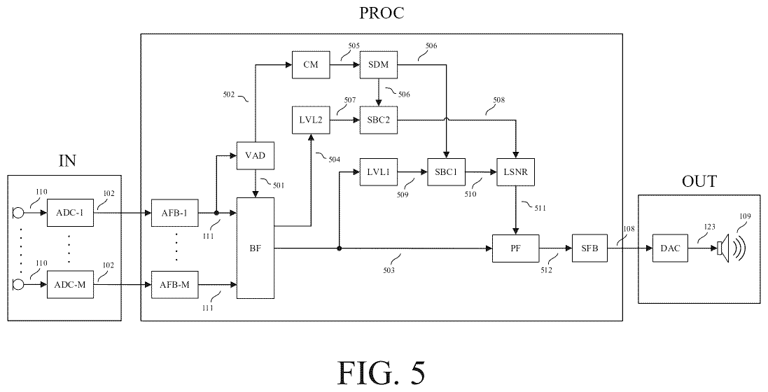

FIG. 5 shows a detailed exemplary block diagram of an example hearing aid according to the present disclosure. The hearing aid comprises an input unit IN, a signal processor PROC, and an output unit OUT. The input unit IN is configured to provide an audio input signal 102 based on a picked-up sound signal from the sound environment. The hearing aid HA comprises an input unit IN comprising a plurality of microphones. The microphones are configured to provide an analog audio input signal 110.

The input unit IN comprises an analog-to-digital converter ADC-1, . . . , ADC-M for each analog audio input signal 110. The analog-to-digital converters analog-to-digital ADC-1, . . . , ADC-M are configured to convert the analog audio input signals 110 to digital audio input signals 102 with a pre-defined sampling rate and bit-resolution. The digital input signals 102 are signals represented in the time-domain. The input unit IN provides the audio input signals 102 based on the digital audio input signals 102.

The signal processor PROC comprises an analysis filter bank AFB-1, . . . , AFB-M for each audio input signal 102. The analysis filter banks AFB-1, . . . , AFB-M are configured to transform the audio input signals 102 into the time-frequency domain from the time domain with a frequency band resolution K₁ and a frame rate F_{S}. The analysis filter banks AFB-1, . . . , AFB-M provide a plurality of time-frequency domain audio input signals 111.

In certain embodiments, the signal processor PROC comprises a voice activity detector VAD configured to detect the presence of speech per time-frequency band in the time-frequency domain audio input signal 111 and provide a voice activity detector output 501 indicative of speech activity in the time-frequency domain audio input signal 111. The voice activity detector VAD is further configured to provide, for each time-frequency domain audio input signal 111, an estimate of the signal-to-noise ratio. The voice activity detector VAD is further configured to provide, based on the estimated signal-to-noise ratio, an estimate of a global signal-to-noise ratio 502. In certain embodiments, the global signal-to-noise ratio 502 being indicative of the average signal-to-noise ratio across frequency bands.

The signal processor PROC can include a beamforming system BF. The beamforming system BF comprises a beamformer for each frequency band. Thus, the number of beamformers is K₁. The beamformers are adaptive beamformers configured to adapt to the background noise based on the voice activity detector output 501, such that when speech is absent, the adaptive beamformers are configured to determine a noise statistic for each frequency band. The adaptive beamformers are configured to reduce, based on the determined noise statistics, the background noise while preserving the desired speech signal when the voice activity detector VAD detects the presence of speech in the time-frequency domain audio input signal 111. The beamforming system BF is configured to provide a beamformed signal 503. The adaptive beamformers are configured to provide, based on the determined noise statistics, a noise signal 504 based on the the time-frequency domain audio input signal 111. The noise signal 504 being indicative of the background noise.

The signal processor PROC comprises a contextual model CM configured to receive the global signal-to-noise ratio 502. The contextual model DM comprises a plurality of linear functions configured to provide a dependency parameter 505. In certain embodiments, the relation between the global signal-to-noise ratio 502 and the dependency parameter 505 may be expressed as

$$α = {f}_{c} ( β ) = min ( {p}_{2} , max ( {p}_{1} , {a}_{1} \cdot β + {a}_{2} ) ) ,$$

where p₁, p₂, a₁, and a₂ are pre-determined parameters determined by a hearing aid developer, and β is the global SNR 502, and α is the dependency parameter 505.

The signal processor PROC comprises a sub-band dependency model SDM configured to receive the dependency parameter 505. The contextual model CM comprises an exponential function configured to provide a plurality of mixing weights 506. In certain embodiments, the relation between the dependency parameter 505 and the mixing weights 506 may be expressed as

$${t}_{n , m} = {α}^{\vert n - m \vert} ,$$

where t_{n,m} represents the mixing weight of the n'th column element and m'th row element of a mixing matrix. The mixing matrix being the mixing weights organized into a matrix representation. The mixing matrix may be expressed as

$$T ( α ) = [ \begin{matrix}1 & α & {α}^{2} & {α}^{3} & {α}^{4} & … & {α}^{N - 1} \\ α & 1 & α & {α}^{2} & {α}^{3} & … & {α}^{N - 2} \\ {α}^{2} & α & 1 & α & {α}^{2} & … & {α}^{N - 3} \\ {α}^{3} & {α}^{2} & α & 1 & α & … & {α}^{N - 4} \\ ⋮ & ⋮ & ⋮ & ⋮ & ⋮ & … & ⋮ \\ {α}^{N - 1} & {α}^{N - 2} & {α}^{N - 3} & {α}^{N - 4} & {α}^{N - 5} & … & 1\end{matrix} ] ,$$

where the element of the first column first row of the mixing matrix corresponds to t_{1,1}, and the element of the first column second row of the mixing matrix corresponds to t_{2,1}, and the element of the second column second row of the mixing matrix corresponds to t_{2,2}. The sub-band dependency model SDM is configured to provide the mixing matrix 506.

The signal processor PROC comprises a first level estimator LVL1. The first level estimator LVL1 is configured to provide, based on the beamformed signals 503, a plurality of first sub-band combiner input signals 509. The first sub-band combiner input signals 509 are determined by first computing the absolute-square value of the beamformed signals 503 to provide a plurality of beamformed absolute-squared signals and second low-pass filtering the beamformed absolute-squared signals.

The signal processor PROC comprises a second level estimator LVL2. The second level estimator LVL2 is configured to provide, based on the noise signals 504, a plurality of second sub-band combiner input signals 507. The second sub-band combiner input signals 507 are determined by first computing the absolute-square value of the noise signals to provide a plurality of noise absolute-squared signals and second low-pass filtering the noise absolute-squared signals.

The signal processor PROC comprises a first sub-band combiner SBC1. The first sub-band combiner SBC1 is configured to receive the mixing matrix 506, i.e., the mixing weights 506, and the first sub-band combiner input signals 509. The first sub-band combiner SBC1 is configured to provide, based on the mixing matrix 506 and the first sub-band combiner input signals 509, a plurality of first combined sub-band signals 510 by a linear transformation. The first combined sub-band signals 510 may be expressed as

$${y}_{n} = {\sum }_{m = 1}^{{K}_{2}} {t}_{n , m} \cdot {x}_{m} , for n = 1 , … , N ,$$

where xₘ represents the first sub-band combiner input signal 509 of the m'th frequency band, and yₙ represents the first combined sub-band signal 510 of the n'th frequency band.

The signal processor PROC comprises a second sub-band combiner SBC2. The second sub-band combiner is configured to receive the mixing matrix 506, i.e., the mixing weights 506, and the second sub-band combiner input signals 509. The second sub-band combiner SBC2 is configured to provide, based on the mixing matrix 506 and the second sub-band combiner input signals 507, a plurality of second combined sub-band signals 508 by a linear transformation. The second combined sub-band signals 508 may be expressed as

$${y}_{n} = {\sum }_{m = 1}^{{K}_{2}} {t}_{n , m} \cdot {v}_{m} , for n = 1 , … , N ,$$

where vₘ represents the second sub-band combiner input signal 507 of the m'th frequency band, and zₙ represents the second combined sub-band signal 508 of the n'th frequency band.

In certain embodiments, the signal processor PROC comprises a local signal-to-noise ratio estimator LSNR. The local signal-to-noise ratio LSNR is configured to receive the first combined sub-band signals 510 and the second combined sub-band signals 508. The local signal-to-noise ratio LSNR is configured to provide an estimate of a local signal-to-noise ratio value for each frequency band, based on the first combined sub-band signals 510 and the second combined sub-band signals 508. The local signal-to-noise ratio value 511 may be determined as the ratio between the first combined sub-band signals 510 and the second combined sub-band signals 508.

The signal processor PROC comprises a post-filter PF. In certain embodiments, the post-filter PF comprises a Wiener filter. The post-filter PF is configured to receive the estimated local signal-to-noise ratio value 511, and the beamformed signal-to-noise 503. The post filter PF is configured to determine a post-filter gain for each frequency band based on the local signal-to-noise ratio value 511. The post-filter gain may be expressed as

$${g}_{n} = \frac{ξ}{1 + ξ} ,$$

where ξ represents the estimated local signal-to-noise ratio 511, and gₙ represents the post-filter gain. The post-filter PF is configured to provide a plurality of enhanced signals 512. The enhanced signals 512 may be determined as

$${s}_{n} = {g}_{n} \cdot {b}_{n} ,$$

where bₙ represents the beamformed signals 203 of the n'th frequency band, and sₙ represents the enhanced signals 512 of the n'th frequency band.

The signal processor PROC comprises a synthesis filter bank SFB configured to transform the enhanced signal from the time-frequency domain to the time domain. The synthesis filter bank SFB provides, based on the time domain enhanced signal 512, a processed audio signal 108.

The hearing aid comprises an output unit OUT configured to receive the processed audio signal 108. The output unit OUT comprises a digital-to-analog converter DAC configured to convert the processed audio signal 108 from a digital signal to an analog signal and provide an analog processed audio signal 123. The output unit OUT comprises a loudspeaker configured to provide, based on the analog processed audio signal 123, an auditory output sound 109 being heard by the hearing aid user.

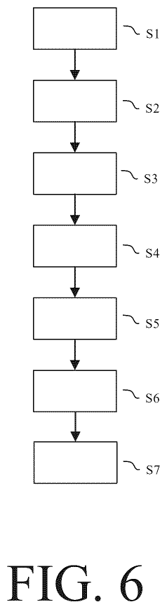

FIG. 6 shows an exemplary block diagram of an example method for providing an auditory output sound according to the present disclosure. The method comprises, in step S1, receiving, by an input unit, a sound signal and providing, by an input unit, an audio input signal indicative of sound. The method comprises, in step S2, providing, by a signal processor, a plurality of sub-band signals based on the audio input signal. The method comprises, in step S3, combining, by the signal processor PROC comprising a sub-band combiner, a plurality of sub-band combiner input signals based on the sub-band signals. The method comprises, in step S4, providing, by the sub-band combiner, a plurality of combined sub-band signals based on a contextual parameter. The method comprises, in step S5, determining, by the signal processor, a processing parameter based on the combined sub-band signals. The method comprises, in step S6, providing, by the signal processor PROC comprising the processing parameter, a processed audio signal based on the audio input signal. The method comprises, in step S7, providing, by an output unit, an auditory output sound based on the processed audio signal, wherein the auditory output sound is indicative of the sound environment.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure, or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Enumerated List of Items

Item 1. A hearing aid comprising:
an input unit configured to provide an audio input signal based on a sound signal indicative of a sound environment;
a signal processor configured to determine a plurality of sub-band signals based on the audio input signal;
wherein the signal processor comprises a sub-band combiner configured to combine a plurality of sub-band combiner input signals based on the plurality of sub-band signals, and configured to determine a plurality of combined sub-band signals based on a contextual parameter indicative of the sound environment;
wherein the signal processor is configured to provide a processed audio signal based on the audio input signal and a processing parameter, and wherein the processing parameter is determined based on the plurality of combined sub-band signals; and
an output unit configured to receive the processed audio signal and configured to provide, based on the processed audio signal, an auditory output sound indicative of the sound environment.

Item 2. The hearing aid according to item 1, wherein the sub-band combiner is configured to combine, based on a dependency parameter, the plurality of sub-band combiner input signals, and wherein the dependency parameter is indicative of a dependency between the plurality of sub-band signals, and wherein the dependency parameter is determined based on the contextual parameter, and wherein the dependency parameter is indicative of a desired dependency between the sub-band combiner input signals.

Item 3. The hearing aid according to item 1 or 2, wherein the signal processor (PROC) is configured to determine the contextual parameter based on the audio input signal.

Item 4. The hearing aid according to any one of items 1-3, wherein the contextual parameter is one or more of following: a signal-to-noise ratio, a noise level, and a voice activity value.

Item 5. The hearing aid according to item 2 or any one of items 3-4 in dependence of item 2, wherein the sub-band combiner is configured to provide, based on a plurality of mixing weights, the plurality of combined sub-band signals by mixing the plurality of sub-band combiner input signals, wherein the mixing weights are determined based on the dependency parameter.

Item 6. The hearing aid according to item 5, wherein the mixing weights are determined based on a sub-band dependency model SDM indicative of a relation between the dependency parameter and the mixing weights.

Item 7. The hearing aid according to item 6, wherein the relation between the dependency parameter and the mixing weights is based on an exponential function.

Item 8. The hearing aid according to any one of items 1-7, wherein the signal processor comprises an energy matcher configured to provide, based on the plurality of combined sub-band signals, a plurality of energy-matched sub-band signals, and wherein the plurality of energy-matched sub-band signals and the plurality of sub-band combiner input signals match in energy, and wherein the processing parameter is determined based on the energy-matched sub-band signals.

Item 9. The hearing aid according to item 8, wherein the energy matcher is configured to provide, based on a matching parameter, the energy-matched sub-band signals, and where the matching parameter is determined based on the dependency parameter.

Item 10. The hearing aid according to item 2 or any one of items 3-9 in dependence of item 2, wherein the dependency parameter is determined based on a contextual model indicative of a relation between the contextual parameter and the dependency parameter.

Item 11. The hearing aid according to item 10, wherein the relation between the contextual parameter and dependency parameter is based on an affine model or a sigmoid model.

Item 12. The hearing aid according to items 10 or 11, wherein the relation between the contextual parameter and dependency parameter is based on a contextual perceptual model.

Item 13. The hearing aid according to any one of items 1-12, wherein the signal processor comprises a level estimator configured to provide, based on the plurality of sub-band signals, the plurality of sub-band combiner input signals, and wherein the sub-band combiner input signals are indicative of an energy of the sub-band signals.

Item 14. The hearing aid according to any one of items 1-13, wherein the processing parameter is determined based on the plurality of combined sub-band signals and a gain map, wherein the gain map is indicative of a relation between the combined sub-band signals and the processing parameter in dependence of an audiogram.

Item 15. The hearing aid according to any one of items 1-14, wherein the hearing aid comprises a microphone configured to pick up audio from a sound environment, and wherein the sound signal is the picked-up audio.

Item 16. A method for providing an auditory output sound comprising:
receiving, by an input unit, a sound signal;
providing, by the input unit, an audio input signal indicative of a sound environment;
providing, by a signal processor, a plurality of sub-band signals based on the audio input signal;
combining, by a sub-band combiner of the signal processor, a plurality of sub-band combiner input signals based on the plurality of sub-band signals;
providing, by the sub-band combiner, a plurality of combined sub-band signals based on a contextual parameter;
determining, by the signal processor, the processing parameter based on the plurality of combined sub-band signals;
providing, by the signal processor and based on a processing parameter, a processed audio signal based on the audio input signal; and providing, by an output unit, an auditory output sound based on the processed audio signal, wherein the auditory output sound is indicative of the sound environment.

1. A hearing aid comprising:
an input unit (IN) configured to provide an audio input signal (102) based on a sound signal (101) indicative of a sound environment;
a signal processor (PROC) configured to determine a plurality of sub-band signals (103) based on the audio input signal (102);
wherein the signal processor (PROC) comprises a sub-band combiner (SBC) configured to combine a plurality of sub-band combiner input signals (104) based on the plurality of sub-band signals (103), and configured to determine a plurality of combined sub-band signals (105) based on a contextual parameter (114) indicative of the sound environment;
wherein the signal processor (PROC) is configured to provide a processed audio signal (108) based on the audio input signal (102) and a processing parameter (107), and wherein the processing parameter (107) is determined based on the plurality of combined sub-band signals (105); and
an output unit (OUT) configured to receive the processed audio signal (108) and configured to provide, based on the processed audio signal (108), an auditory output sound (109) indicative of the sound environment.

2. The hearing aid according to claim 1, wherein the sub-band combiner (SBC) is configured to combine, based on a dependency parameter (106), the plurality of sub-band combiner input signals (104), and wherein the dependency parameter (106) is indicative of a dependency between the plurality of sub-band signals (113), and wherein the dependency parameter (106) is determined based on the contextual parameter (106), and wherein the dependency parameter (106) is indicative of a desired dependency between the sub-band combiner input signals (104).

3. The hearing aid according to claim 1, wherein the signal processor (PROC) is configured to determine the contextual parameter (114) based on the audio input signal (102).

4. The hearing aid according to claim 1, wherein the contextual parameter (114) is one or more of following: a signal-to-noise ratio, a noise level, and a voice activity value.

5. The hearing aid according to claim 2, wherein the sub-band combiner is configured to provide, based on a plurality of mixing weights (115), the plurality of combined sub-band signals (105) by mixing the plurality of sub-band combiner input signals (104), and wherein the mixing weights (115) are determined based on the dependency parameter (115).

6. The hearing aid according to claim 5, wherein the mixing weights (115) are determined based on a sub-band dependency model (SDM) indicative of a relation between the dependency parameter (106) and the mixing weights (115).

7. The hearing aid according to claim 6, wherein the relation between the dependency parameter (106) and the mixing weights (115) is based on an exponential function.

8. The hearing aid according to claim 1, wherein the signal processor (PROC) comprises an energy matcher (EM) configured to provide, based on the plurality of combined sub-band signals (105), a plurality of energy-matched sub-band signals (119), and wherein the plurality of energy-matched sub-band signals (119) and the plurality of sub-band combiner input signals (104) match in energy, and wherein the processing parameter (120) is determined based on the energy-matched sub-band signals (119).

9. The hearing aid according to claim 8, wherein the energy matcher (EM) is configured to provide, based on a matching parameter, the energy-matched sub-band signals (119), and where the matching parameter is determined based on the dependency parameter (115).

10. The hearing aid according to claim 2, wherein the dependency parameter (106) is determined based on a contextual model (CM) indicative of a relation between the contextual parameter (114) and the dependency parameter (115).

11. The hearing aid according to claim 10, wherein the relation between the contextual parameter (114) and dependency parameter (106) is based on an affine model or a sigmoid model.

12. The hearing aid according to claim 10, wherein the relation between the contextual parameter (114) and dependency parameter (106) is based on a contextual perceptual model.

13. The hearing aid according to claim 1, wherein the signal processor (PROC) comprises a level estimator (LVL) configured to provide, based on the plurality of sub-band signals (113), the plurality of sub-band combiner input signals (104), and wherein the sub-band combiner input signals (104) are indicative of an energy of the sub-band signals.

14. The hearing aid according to claim 1, wherein the processing parameter (120) is determined based on the plurality of combined sub-band signals (105) and a gain map (GMP), wherein the gain map (GMP) is indicative of a relation between the combined sub-band signals (105) and the processing parameter (120) in dependence of an audiogram.

15. A method for providing an auditory output sound, the method comprising:
receiving, by an input unit, a sound signal;
providing, by the input unit, an audio input signal indicative of a sound environment;
providing, by a signal processor, a plurality of sub-band signals based on the audio input signal;
combining, by a sub-band combiner of the signal processor, a plurality of sub-band combiner input signals based on the plurality of sub-band signals;
providing, by the sub-band combiner, a plurality of combined sub-band signals based on a contextual parameter;
determining, by the signal processor, the processing parameter based on the plurality of combined sub-band signals;
providing, by the signal processor and based on a processing parameter, a processed audio signal based on the audio input signal; and
providing, by an output unit, an auditory output sound based on the processed audio signal, wherein the auditory output sound is indicative of the sound environment.
